(19) United States
(12) Patent Application Publication
(10) Pub. No.: US 2025/0239812 A1
(43) Pub. Date: Jul. 24, 2025

(54) CONNECTOR

(71) Applicant: TOYOTA JIDOSHA KABUSHIKI KAISHA, Toyota-shi (JP)

(72) Inventor: Tomohiro IMAO, Toyota-shi (JP)

(73) Assignee: TOYOTA JIDOSHA KABUSHIKI KAISHA, Toyota-shi (JP)

(21) Appl. No.: 18/823,051

(22) Filed: Sep. 3, 2024

(30) Foreign Application Priority Data
Jan. 23, 2024 (JP) 2024-007851

(51) Int. Cl. H01R 13/631

(52) U.S. Cl. CPC H01R 13/631

(57) ABSTRACT

The connector includes a main body portion, a first connecting portion provided on the front side of the main body portion and connectable to the terminal, a second connecting portion provided on the back side of the main body portion and connectable to the object to be connected, and a pair of projecting portions extending in opposite directions from both side edges of the main body portion on the front side of the main body portion. The projecting portions have pressing surfaces that are curved and recessed on the front side, and the pressing surfaces are configured such that a finger of an operator is pressed against the pressing surfaces at a time of connection to the connection target.

### CROSS-REFERENCE TO RELATED APPLICATION

This application claims priority to Japanese Patent Application No. 2024-007851 filed on Jan. 23, 2024, incorporated herein by reference in its entirety.

### BACKGROUND

### 1. Technical Field

The present disclosure relates to a connector including a first connecting portion on a front side and a second connecting portion on a rear side.

### 2. Description of Related Art

Japanese Unexamined Patent Application Publication No. 2001-110523 (JP 2001-110523 A) discloses a connector having a lock arm provided on an outer upper surface of a female housing and an operation portion positioned behind the lock arm. A recessed portion is formed on an upper surface of the operation portion, and the recessed portion has an inclined surface that is inclined downward on the front side and an abutment wall that is inclined upward from a front end of the inclined surface.

### SUMMARY

According to the technology described in JP 2001-110523 A, the outer upper surface of the connector is recessed to form the abutment wall, it is thus not possible to sufficiently secure the size of the abutment wall, and it is difficult to hook a finger.

An object of the present disclosure is to provide a connector that allows an operator to easily press his/her finger against the connector when the operator pushes the connector into a port of a connection target.

In order to solve the above problem, a connector according to an aspect of the present disclosure includes:
a body portion;
a first connecting portion that is provided on a front side of the body portion and is connectable to a terminal;
a second connecting portion that is provided on a rear side of the body portion and is connectable to a connection target; and
a pair of projecting portions that project in mutually opposite directions from both side edges of the body portion on the front side of the body portion.
   The projecting portions have pressing surfaces that are curved and recessed on the front side, and
   The pressing surfaces are configured such that a finger of an operator is pressed against the pressing surfaces at a time of connection to the connection target.

According to the present disclosure, it is possible to provide a connector that allows an operator to easily press his/her finger against the connector when the operator pushes the connector into a port of a connection target.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a connector of an embodiment; and

FIG. 2 is a diagram for explaining a method of using the connector.

### DETAILED DESCRIPTION OF EMBODIMENTS

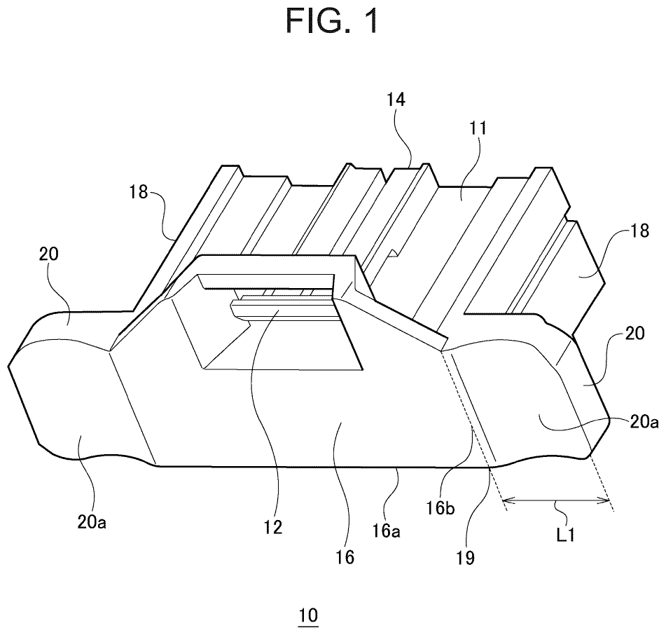

FIG. 1 is a perspective view of a connector 10 according to an embodiment. The connector 10 includes a main body portion 11, a first connecting portion 12, a second connecting portion (not shown), a pushing portion 14, a surface 16, a side surface 18, and a projecting portion 20. The connector 10 is used, for example, to connect a harness to a connection target such as an in-vehicle device.

The main body portion 11 of the connector 10 is formed in a substantially rectangular parallelepiped shape, and the surface 16 of the main body portion 11 is formed in a substantially rectangular shape. The surface 16 has a long side portion 16a and a short side portion 16b. The first connecting portion 12 is provided on the surface 16 of the main body portion 11, and the second connecting portion is provided on the back side of the main body portion 11. The first connecting portion 12 is connectable to a terminal of the harness.

The pushing portion 14 has a second connecting portion on the inner side, and is located on the back side of the main body portion 11. The second connecting portion is connected to the first connecting portion 12 inside the connector 10, and is located on the back side of the first connecting portion 12. The pushing portion 14 is pushed into the connection target object by the operator.

A pair of projecting portions 20 are provided on the surface 16 side, and protrude from both side edges 19 on the short side portion 16b side in opposite directions. The projecting portion 20 protrudes vertically from the side surface 18 of the main body portion 11. The projecting portion 20 is formed in a rectangular plate shape. The pair of projecting portions 20 protrude from the short side portion 16b, and thus can be disposed further away than protruding from the long side portion 16a.

The projecting portion 20 has a pressing surface 20a that is curved and recessed toward the front side. The pressing surface 20a is curved in an arc shape when viewed along the short side portion 16b. The pressing surface 20a bends so that it is easy to press the operator's finger, particularly the back of the finger. When the pressing surface 20a extends uniformly with the surface 16, the operator can press the pressing surface 20a together with the surface 16.

The projecting portion 20 is formed so as not to protrude from the main body portion 11 along the short side portion 16b. Accordingly, the length of the connector 10 along the short side portion 16b can be suppressed.

The protruding length L1 of the projecting portion 20 is set to a size to be pressed against the belly and/or the back of the human finger, and is set to, for example, 1 centimeter or more. The protruding lengths L1 of the pair of projecting portions 20 are the same.

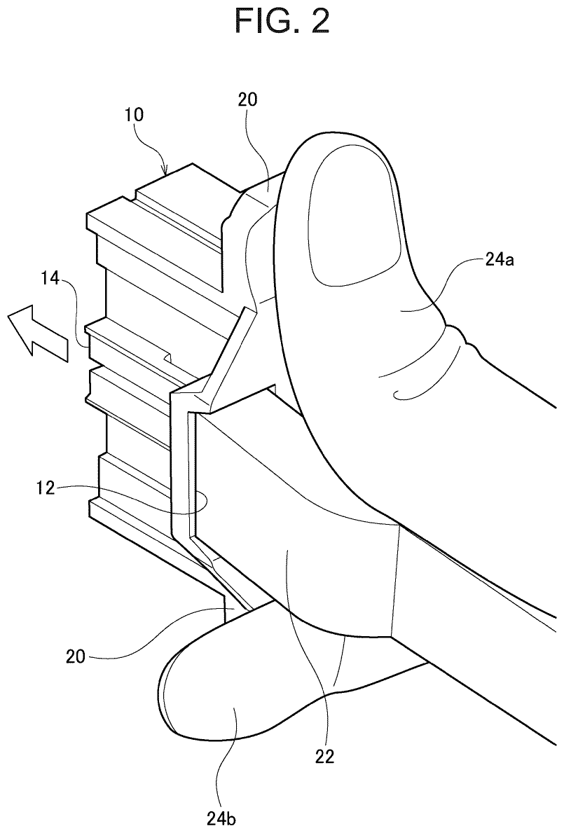

FIG. 2 is a diagram for explaining a method of using the connector 10. A harness terminal 22 is connected to the first connecting portion 12 of the connector 10. The operator applies the belly of the thumb 24a to one of the projecting portions 20 and the back of the index finger 24b to the other projecting portion 20 with respect to the connector 10 to which the harness terminal 22 is connected. The operator pinches the harness terminal 22 with the thumb 24a and the index finger 24b, and pushes the pushing portion 14 into the port of the object to be connected.

The pressing surface 20a is pressed against a finger of an operator when connecting to an object to be connected. If the projecting portion 20 is not provided, the operator pushes the corner of the main body portion 11, and if the pushing operation is repeated many times, there is a possibility that the finger may be damaged. By providing the projecting portion 20, the connector 10 can be pushed more easily than in the case where the projecting portion 20 is not provided.

When the pair of projecting portions 20 protrude from the short side portion 16b side, the pair of projecting portions 20 can be set to be easily pushed by the thumb 24a and the index finger 24b. Since the projecting portion 20 can be pushed by the abdomen of the thumb 24a and the back of the index finger 24b, the contact area with the finger is increased, and the burden on the finger during the pushing operation can be reduced.

The present disclosure has been described above based on examples. The present disclosure is not limited to the above-described embodiments, and various modifications such as design changes can be made based on knowledge of a person skilled in the art.

What is claimed is:

1. A connector comprising:
a body portion;
a first connecting portion that is provided on a front side of the body portion and is connectable to a terminal;
a second connecting portion that is provided on a rear side of the body portion and is connectable to a connection target; and
a pair of projecting portions that project in mutually opposite directions from both side edges of the body portion on the front side of the body portion, wherein
the projecting portions have pressing surfaces that are curved and recessed on the front side, and
the pressing surfaces are configured such that a finger of an operator is pressed against the pressing surfaces at a time of connection to the connection target.

2. The connector according to claim 1, wherein
a surface of the body portion is formed in a substantially rectangular shape and has short side portions and long side portions, and
the projecting portions project from the short side portions.

3. The connector according to claim 2, wherein the projecting portions are formed in arc shapes in a view in a direction along the short side portions.

4. The connector according to claim 1, wherein a projecting length of each of the projecting portions is set to a size that allows a back of a finger of a person to be pressed against the projecting portions.
